(19) United States
(12) Patent Application Publication
(10) Pub. No.: US 2005/0258927 A1
(43) Pub. Date: Nov. 24, 2005

(54) Simplified harmonic-free constant-voltage transformer

(76) Inventor: Weimin Lu, Novi, MI (US)

Correspondence Address: Donald P. Gillette, P.O. Box 655, Saline, MI, 48176, US

(21) Appl. No.: 10/197,999

(22) Filed: Jul. 17, 2002

(51) Int. Cl. H01F 27/24

(52) U.S. Cl. 336/234

(57) ABSTRACT

A ferroresonant transformer to produce an output voltage that has a substantially constant output voltage that is substantially free of harmonics includes a ferromagnetic core with a winding part and primary and secondary windings on that part. The core also includes a flux return part. Magnetic shunts magnetically couple some of the flux from the core between the primary and secondary windings to the flux return part. The core includes a region with a reduced cross-sectional area that constitutes an air gap to form a built-in inductor. The remainder of the core works with the secondary winding and a resonating capacitor to generate a substantially harmonic-free, constant-voltage output. The transformer may have one set of primary-secondary windings if it is to operate on single-phase alternating current, or it may have multiple sets if it is to operate on multi-phase alternating current.

### BACKGROUND OF THE INVENTION

1. Field of the Invention

This invention relates to ferromagnetic constant-voltage, or CV, transformers that, when energized by an alternating voltage of a given frequency and an amplitude that is within about ±15% of a nominal value, produce a substantially undistorted, or harmonic-free, output voltage that has an amplitude within about ±3% of a selected value.

Some prior art transformers that have only two coils are capable of holding the magnitude of their output voltage to within ±3% of a nominal value, but the waveform of the output voltage, instead of being a substantially pure sine wave, has a relatively high harmonic content, typically with 3rd, 5th, 7th, and even higher harmonics of the fundamental frequency. Other prior art transformers capable of holding the magnitude of their output voltage relatively constant, require an additional coil to minimize harmonics.

Transformers constructed according to this invention achieve an output voltage of relatively constant magnitude and low harmonic content and do so without the necessity of a third coil.

By virtue of the elimination of the extra coil, the transformers described and claimed hereinafter are less expensive than prior transformers that achieve the same voltage control and relative freedom of harmonics. In addition, the structural simplification of this invention is not limited to single-phase transformers but also extends to three-phase transformers.

The advantages of being able to achieve an output voltage that is both substantially constant in magnitude and harmonic-free with only two coils, or in the case of three-phase transformers, two coils per phase, include simplification of manufacture, improvement of efficiency, reduction of the cost and size of transformers of a given capacity, and, even in the case of three-phase transformers, requirement of only a single magnetic core.

In addition to the foregoing advantages of this invention, the fact that the output voltage is sinusoidal results in a lower temperature rise in the secondary winding, in the secondary winding section of the magnetic core, and in the capacitor used with such transformers than would be the case if the voltage waveform were distorted.

In order to produce a sinusoidal, i.e., harmonic-free, output voltage of substantially fixed amplitude in prior Cv transformers having only two coils, an additional external inductor is required, but the present invention uses air gap means to form, in effect, an inductor within and in series with the secondary winding. A capacitor of the proper capacitance is connected to the secondary to tune the built-in inductor to filter out, or at least substantially reduce the amplitude of, undesired harmonics in the output voltage. Air gap means may consist of one or more complete spaces, or gaps, across the flux lines in the ferromagnetic components of a transformer core, or air gap means may be only a narrowing at a selected region, or regions, of a ferromagnetic core.

U.S. Pat. No. 2,694,177 to Sola describes the use of a tertiary coil to buck against the harmonics to provide sinusoidal alternating voltage output.

U.S. Pat. No. 5,912,553 to Mengelkoch describes the use of a tertiary coil isolated and spaced from the secondary coil to create a filter circuit that provides a sinusoidal output voltage.

There are a number of disadvantages in the use of a tertiary coil in a constant-voltage transformer. First, the production of the tertiary coil requires both additional time and materials. It also requires that the size of the core be large enough to allow space for a separate window to accommodate the tertiary coil or to allow the window for the secondary coil to be long enough to accommodate the tertiary coil as well as the primary and secondary coils. Either way, the result is a larger transformer. For example, in the Sola patent, there is additional magnetic structure between the secondary coil and the tertiary coil to form a separate window for the tertiary coil.

In the Mengelkoch patent, the secondary and tertiary coils are within the same window but are spaced apart, which requires the window to be large enough to accommodate the tertiary coil along with the primary and secondary coils.

Still another objection to the use of a tertiary coil is that a ferroresonant transformer so equipped has reduced efficiency. This shows up in Sola Patent 2,694,177 in extreme distortion of the waveform in the tertiary coil, meaning that the waveform has a high content of harmonics, along with a high core loss and temperature rise. While Sola includes components to reduce this distortion, it is preferable not to produce it in the first place.

Mengelkoch's single phase transformer has air gaps that extend the fully across all three legs of his lamination stack, thereby creating high reluctance in the magnetic circuit, which severely reduces the regulation of the transformer at low source voltage.

### OBJECTS AND SUMMARY OF THE INVENTION

It is an object of this invention to provide an improved ferroresonant transformer that produces a substantially harmonic-free output voltage and has less components, in both the single-phase and three-phase forms, than prior harmonic-free constant-voltage transformers capable of producing comparable output voltage characteristics, thereby resulting in a smaller, simpler structure that is easier and less costly to manufacture and has improved efficiency.

Another object is to produce a ferroresonant constant-voltage transformer that produces a sinusoidal output voltage and has lower temperature rise in the secondary winding section and in the magnetic core on which the secondary is wound and in the capacitor associated with the magnetic structure than is true of comparable components of a prior constant-voltage transformer designed to handle the same load.

A further object is to utilize the magnetic core structure of the transformer to eliminate the necessity of a tertiary, or neutralizing, coil while still achieving a substantially harmonic-free output voltage of substantially constant magnitude.

A similar object is to utilize the magnetic core structure of a multi-phase transformer to eliminate the necessity of providing a tertiary, or neutralizing, coil for each phase to achieve a substantially harmonic-free output voltage of substantially constant magnitude.

A still further object is to provide a ferroresonant transformer that produces, in response to alternating source voltage having a certain frequency, an output voltage substantially free of harmonics and having a substantially constant magnitude, such transformer comprising a core loop of low-reluctance transformer material having a selected length and comprising ferromagnetic winding leg means to conduct magnetic flux, and a ferromagnetic return leg means to conduct magnetic flux; primary winding means located on a first part of the winding leg means and comprising input terminals to receive the alternating source voltage to produce the magnetic flux in the winding leg means; secondary winding means on a second part of the winding leg means spaced from the first part of the winding leg means and comprising a plurality of terminals, including output terminals; air gap means comprising a region of increased reluctance in the core loop to form an inductor in series with the secondary winding; magnetic flux shunt means, including a series shunt air gap, magnetically joining a location on the winding leg means between the first and second parts thereof to the return leg means to divert from the winding leg means to the return leg means a portion of the magnetic flux produced by the primary winding so that the flux thus diverted by-passes the secondary winding; and capacitor means connected between selected terminals of the secondary winding and having a capacitance that resonates with the secondary winding means at the certain frequency, whereby the substantially harmonic-free sinusoidal output voltage of substantially constant magnitude is produced across the output terminals.

Those skilled in this art may become aware of still further objects after studying the following description.

Briefly, the constant-voltage transformer of this invention includes a primary coil, or winding, a secondary coil, or winding, a ferromagnetic core that has winding leg means and return leg means, which, together, form a core loop. The transformer also includes magnetic shunt assemblies, and air gap means. The primary coil is on a first portion of the winding leg means to be energized by the source voltage, and the secondary winding is on a second portion of the winding leg means spaced from the first portion. The secondary winding is electrically insulated from the primary winding and comprises first, second, and third terminals. The first and second terminals comprise output terminals of the transformer, and the third terminal is between the first and second terminals. In addition, the transformer has air gap means at one or more locations to reduce the cross-sectional area of the core to a lesser amount, including to zero, at that or those locations. In addition, the transformer includes magnetic flux shunt means joining a location on the winding leg means between the first and second portions thereof to shunt the return leg means some of the flux in the part of the core where the primary winding is located. In addition, a capacitor having a capacitance that resonates with the inductance produced in the secondary winding at the certain frequency is connected between the first and third terminals of the secondary winding so that the output voltage produced across the output terminals of the transformer is not only of substantially constant magnitude but is also substantially harmonic-free.

Existing transformers powered by sources in which the magnitude of the input voltage may vary as much as ±15% are considered to be constant-voltage transformers if the magnitude of their output voltage does not vary more than about ±5%. Such constant-voltage transformers may also be considered acceptable if their output waveform does not have more than about 5% harmonic distortion. The same variations from absolute constancy of magnitude and purity of waveform are permissible in transformers constructed according to this invention, but the novel transformers of this invention achieve these desired values more inexpensively than transformers constructed according to the prior art.

There is a possibility of some trade-offs between constancy of magnitude and purity of waveform. Some types of apparatus require that their power supply voltage be held to within about ±1% of the desired value but permit the waveform of that supply voltage to have, perhaps, 5% harmonic distortion. Other apparatus requires that the alternating voltage obtained from the power transformer have as little harmonic distortion as possible, say 3%, but may allow the magnitude of the supply voltage to vary as much as, say ±5% of the nominal value. Small transformers intended for use where the KVA through them is low usually need a power supply voltage that has a total harmonic distortion less than 3%. Large transformers to be used with high KVA systems usually are not as sensitive to harmonic distortion and may operate with a total harmonic distortion of 5%.

One way of building the magnetic core is to use two patterns of E-I laminations in one stack. A partial stack of E-I laminations has an air gap in the magnetic flux loop path linking the secondary coil to form a built-in inductor. The remainder of the total stack consists of E-I laminations that have no air gap.

Another way of building the magnetic core is to use butt-stacked E-I laminations with a shortened winding leg that creates an air gap in the magnetic flux loop path linking the secondary coil to form a built-in inductor electrically in series with the secondary coil.

The magnetic core may also be arranged to have an air gap right in the middle of the stack of laminations to form a built-in inductor. In this way, all laminations may be identical and can be interleaved with each lamination oriented oppositely from its neighbors in the stack to reduce the transformer noise.

The special stack of magnetic core laminations can also be assembled with laminations of one E-I pattern that have a portion of the air gaps in the magnetic loop path linking the secondary coil to form a built-in inductor. The remainder of the magnetic core cooperates with the secondary coil connected to a resonating capacitor to generate a substantially harmonic-free output voltage of substantially constant magnitude.

Constant-voltage transformers according to this invention for use in three-phase systems are similar to those used in single-phase systems. Like the single-phase transformers, transformers intended for use in three-phase systems may have a core with three legs, but all three of the legs, including those that would serve only as flux-return paths in single-phase transformers, have primary and secondary windings and air gap means in each leg and separate capacitors connected to each secondary winding. Each leg serves as a winding leg for one phase and as a return leg for the other phases.

In addition, in both the single-phase and the three-phase embodiments, the air gap means can be located midway along the length of the winding leg, or legs, so that all of the E laminations can be identical while still allowing some, typically alternate, laminations to be reversed in the direction the legs extend from the spine.

### BRIEF DESCRIPTION OF THE DRAWINGS

FIG. 1 shows a transformer according to this invention.

FIG. 2 is a schematic circuit of the ferroresonant transformer of FIG. 1 connected to obtain substantially constant voltage and substantially no harmonics.

FIG. 3 shows a circuit equivalent to that in FIG. 2.

FIG. 4a shows a plan view of one embodiment of a transformer according to this invention, using two patterns of E-I laminations.

FIG. 4b is a side view of the transformer of FIG. 4a.

FIG. 4c is an exploded view of the magnetic core of FIG. 4a.

FIGS. 5a-5c show plan, side, and exploded views of another embodiment of a transformer according to this invention, using two patterns of E-I laminations.

FIGS. 6a-6c show plan, side, and exploded views of another embodiment of a transformer according to this invention, using two patterns of E-I laminations.

FIGS. 7a-7c show plan, side, and exploded views of another embodiment of a transformer according to this invention, using two patterns of E-I laminations.

FIGS. 8a-8c show plan, side, and exploded views of another embodiment of a transformer according to this invention, using two patterns of E-I laminations.

FIGS. 9a and 9b show plan and exploded views of another embodiment of a transformer according to this invention, using one pattern of E-I laminations. Only one set of air gaps are needed, either on the winding leg or on the return legs.

FIGS. 10a and 10b show plan and exploded views of another embodiment of a transformer according to this invention, using one pattern of E-I laminations.

FIGS. 11a and 11b show plan and exploded views of another embodiment of a transformer according to this invention, using one pattern of E-I laminations.

FIGS. 12a and 12b show plan and exploded views of another embodiment of a transformer according to this invention, using T-O laminations. Only one set of air gaps is needed, either on the winding leg or on the return legs.

FIGS. 13a and 13b show plan and exploded views of another embodiment of a transformer according to this invention, using T-O laminations.

FIGS. 14a and 14b show plan and exploded views of another embodiment of a transformer according to this invention, using T-O laminations.

FIG. 15 shows a transformer similar to that in FIG. 1 except that its air gap in the winding leg is a complete air gap, not a partial one.

FIG. 16 shows another form of laminations having partial air gaps centrally located along the length of the center leg.

FIG. 17 shows one embodiment of a three-phase, constant-voltage, harmonic-free transformer according to this invention.

FIG. 18 shows another embodiment of a three-phase, constant-voltage, harmonic-free transformer according to this invention.

FIG. 19 shows the output circuit of a three-phase transformer connected in delta configuration according to this invention.

FIG. 20 shows a wye connection of the output circuit of a three-phase transformer according to this invention.

### DESCRIPTION OF PREFERRED EMBODIMENTS OF THIS INVENTION

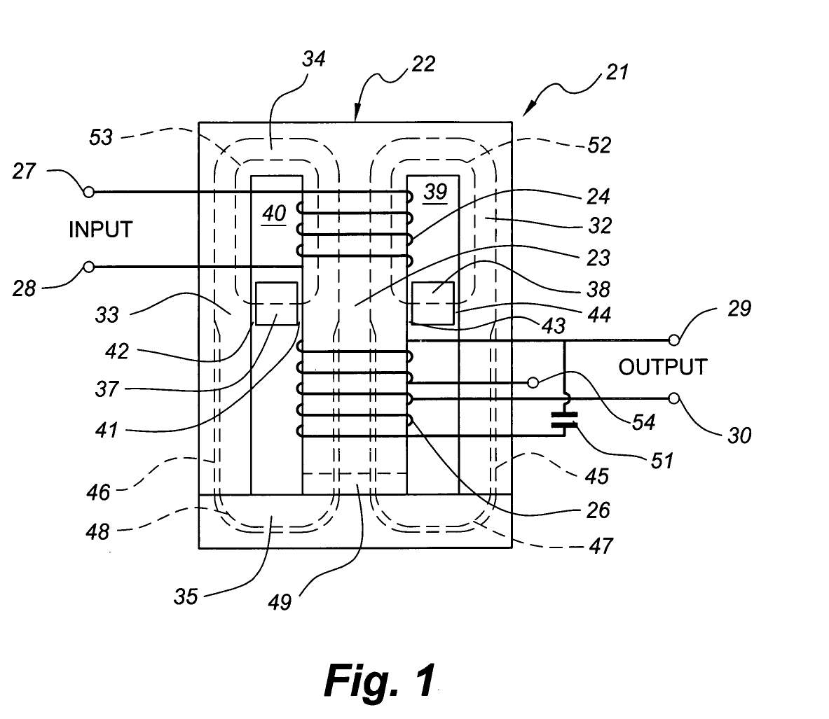

FIG. 1 shows a ferroresonant transformer 21 that includes a ferromagnetic core 22 with a first leg 23 on which a primary winding, or coil, 24 and a secondary winding, or coil, 26 are wound. The core is of ferromagnetic material suitable for use as transformer material. A typical, but by no means exclusive, material for that purpose is M-6 grade 29 gauge transformer material. The primary winding has input terminals 27 and 28 for connection to a source of alternating voltage, and the secondary winding has output terminals 29 and 30 from which an output alternating voltage is to be obtained. In accordance with the desired operation of the transformer, the output voltage is required to have a sinusoidal waveform, which means that it is substantially free of harmonics, and it must also have a substantially constant magnitude, typically within ±3% of a desired value, when the source voltage has a magnitude within a certain range, typically ±15% of a nominal value, such as 120 volts.

In addition to the leg 23, which may also be referred to as winding leg means, the core means 22 also has legs 32-35 forming return core means linked to the leg 23 to provide a relatively low-reluctance environment for magnetic flux generated by currents flowing in the windings. This does not mean that the reluctance is uniformly low at all points, and it will differ in different regions of the core, depending on the characteristics of laminations making up the core and on the existence at certain locations of interruptions forming partial air gaps in the core.

Also forming part of the ferromagnetic material that makes up the core 22 are magnetic shunt means 37 and 38 located within the two windows 39 and 40 formed by the arrangement of the core legs 23 and 32-35. The shunts 37 and 38 extend most of the way from the first leg 23 to the legs 32 and 33 and are between the primary winding 24 and the secondary winding 26. In the arrangement shown in this figure, there is a short air gap 41 between the shunt 37 and the winding leg 23 and another short air gap 42 between the shunt 37 and the return leg 33. There are corresponding air gaps 43 and 44 between ends of the shunt 38 and the legs 23 and 32, respectively. As in all cases, the air gaps 41-44 increase the reluctance of the respective parts of the core in which they are located over what it would be if these air gaps did not exist.

When the primary coil 24 is connected to a source of alternating current, this current produces magnetic flux in the vicinity of the coil, and this flux is channeled by the core members, which have a substantially lower reluctance than air. Some of the flux, indicated by the dotted loops 45 and 46, links with the secondary coil 26 by way of the winding leg 23 and the return legs 32-35. In addition, some of the magnetic flux produced by current in the primary coil 24 is channeled by the magnetic shunts 37 and 38 so that it does not link with the secondary coil.

In addition to the flux 45 and 46, the source current flowing in the coil 24 produces additional flux that follows the paths indicated by reference numerals 47 and 48. Although in the drawing, this flux appears to split off from the flux 45 and 46, it does not really do so but, like all magnetic flux, is really in the form of closed loops. The reason for showing additional flux loops is to illustrate that some of this flux is entirely within the low-reluctance path formed by ferromagnetic material in of the leg 23 but some of it is in a somewhat higher reluctance region resulting from a partial air gap 49 created by shaping the leg 23 so that this part of it has a smaller cross-sectional area than other parts of this leg. Subsequent figures show various embodiments for producing the smaller cross-sectional area that is an important part of this invention.

A capacitor 51 is connected across the entire secondary winding 26 to resonate with the inductance of that winding due to saturation of the winding leg 23 in the secondary coil area when the output voltage reaches the desired value. Any excess flux produced in the core 22 by a higher primary voltage than is necessary to produce the desired output voltage will by-pass the part of the winding leg 23 on which the secondary coil is located and, instead, will follow the paths 52 and 53 through the magnetic shunts 37 and 38. As a result, the voltage across the secondary coil 26 will not increase.

The output voltage of the transformer 21 is not necessarily the voltage across the whole secondary coil 26 but only the voltage across the part of the coil between the terminals 29 and 30. It may also be convenient to provide one or more other taps, such as the tap 54, on the winding 26 to which the output terminal 29 can be connected to set the value of the controlled voltage to exactly the desired, controlled value.

If there were no air gap, such as the one indicated in this embodiment by reference numeral 49, the waveform of the output voltage between the terminals 29 and 30 would not be sinusoidal but relatively square, indicating that it has a high harmonic content. With the partial air gap, there are two parallel magnetic flux paths, one through the air gap, as indicated by the lines 47 and 48, and the other through the ferromagnetic material that bridges the partial air gap 49, as indicated by the flux paths 45 and 46. The flux paths 47 and 48 through the air gap have a higher reluctance than the flux paths 45 and 46 through the ferromagnetic material that bridges the air gap. The flux through the air gap forms a built-in inductor within the secondary winding 26 in series with the secondary winding and the capacitor 51 to eliminate harmonics of the fundamental sinusoidal frequency. The remainder of the stack of laminations without an air gap forms a low-reluctance magnetic path to carry out output power with maximum efficiency.

One way of building the special magnetic core 22 of this invention is to assemble a stack of laminations made up of two E-I patterns, one of which has an air gap and the other of which does not. The laminations in one part of the stack have an air gap in the magnetic flux loop paths 47 and 48 that link with the secondary coil to form a built-in inductor. The laminations in the rest of the stack, have no air gap and work with the secondary coil 26 connected to the resonating capacitor 51 to generate a constant-voltage output.

Another way of building the special stack of magnetic core laminations is to use a single-pattern set of E-I laminations or a single-pattern set of T-O laminations with reductions in the cross-sectional area of all of the laminations in one location of the magnetic flux loop path linking the secondary coil to form a built-in inductor. The remainder of the magnetic core works with the secondary coil 26 connected to the resonating capacitor 51 to generate a constant-voltage output.

In each case, the built-in inductor within the secondary coil 26 also works with the capacitor 51 as a filter to eliminate harmonics and produce an output voltage that has a substantially constant amplitude and is substantially harmonic-free.

A specific embodiment of a constant-voltage, harmonic-free transformer, such as the transformer 60 with the partial air gap 49 in FIG. 1, has been constructed according to the specifications in the following Table I:

TABLE I

| | |
|---|---|
| VA rating: | 600 VA at 60 Hz |
| Input voltage: | 120 Volts ±15% |
| Output voltage: | 120 Volts ±3% |
| Lamination core without air gap: | 0.25″ stack of FR-1625, M6, |
| | 29-gauge laminations |
| Lamination core with air gap: | 1.75″ Stack Of FR-1625, M6, |
| | 29-gauge laminations with 0.1″ |
| | air gap in the center leg |
| Shunt assembly, each: | 0.63″ stack of M6, 29-gauge |
| | laminations with 0.031″ shunt air |
| | gap |
| Primary coil: | 130 turns for input |
| Secondary coil: | 450 turns, tapped @ 90 turns for |
| | output |
| Capacitor: | 33 μF |

The results are stated in the following Table II:

TABLE II

| | | | | | Tot. Harm. |
|---|---|---|---|---|---|
| Input | | Output | | Regulation | Distort'n |
| 102 V | 7.16 A | 108 V | 5.49 A | 1.8% under 110 V | 2.2% |
| 120 V | 6.30 A | 110 V | 5.51 A | | 3.9% |
| 138 V | 5.94 A | 111 V | 5.55 A | 0.9% over 110 V | 5.7% |

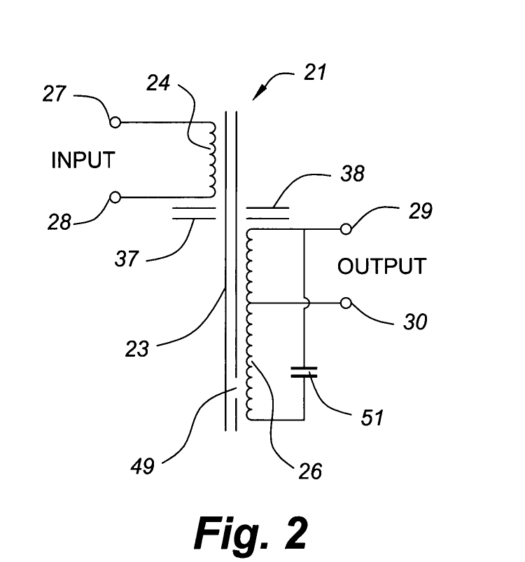

FIG. 2 is the schematic circuit diagram of the transformer 21 in FIG. 1, and corresponding components have been identified by the same reference numerals. This circuit contains no physical inductor to produce harmonic-free output voltage, and has been required in constant-voltage transformers previously

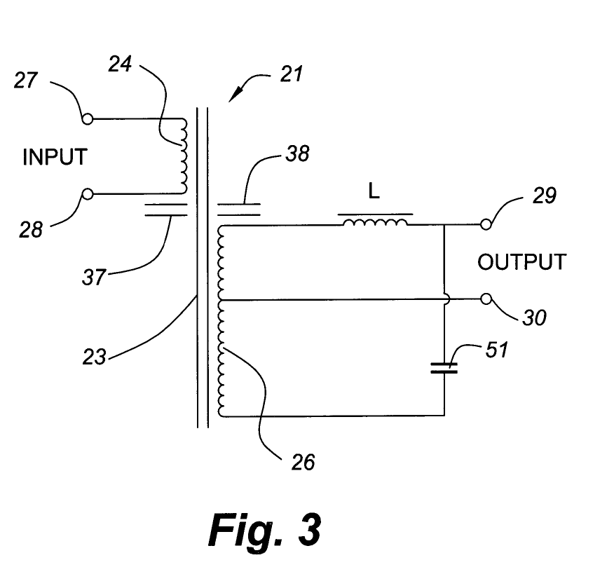

FIG. 3 shows a circuit equivalent to that in FIG. 2 in operation. The circuit in FIG. 3 appears to have a separate inductor L connected to the secondary winding to filter out harmonics in the output voltage, as is commonly done in regular constant-voltage transformers, the inductor L is produced only by operation of the actual components, including the partial air gap 49 in FIG. 1. Hence, the filtering inductor that is required in prior constant-voltage transformers is unnecessary in the transformer as claimed herein. The effective inductor L and the capacitor 51 form a circuit tuned to the fundamental frequency of the alternating voltage applied to the terminals 27 and 28 of the primary coil 24. As may be seen, the partial air gap 49 is at the secondary end of the winding leg 23, although it may also be located elsewhere in the transformer 21.

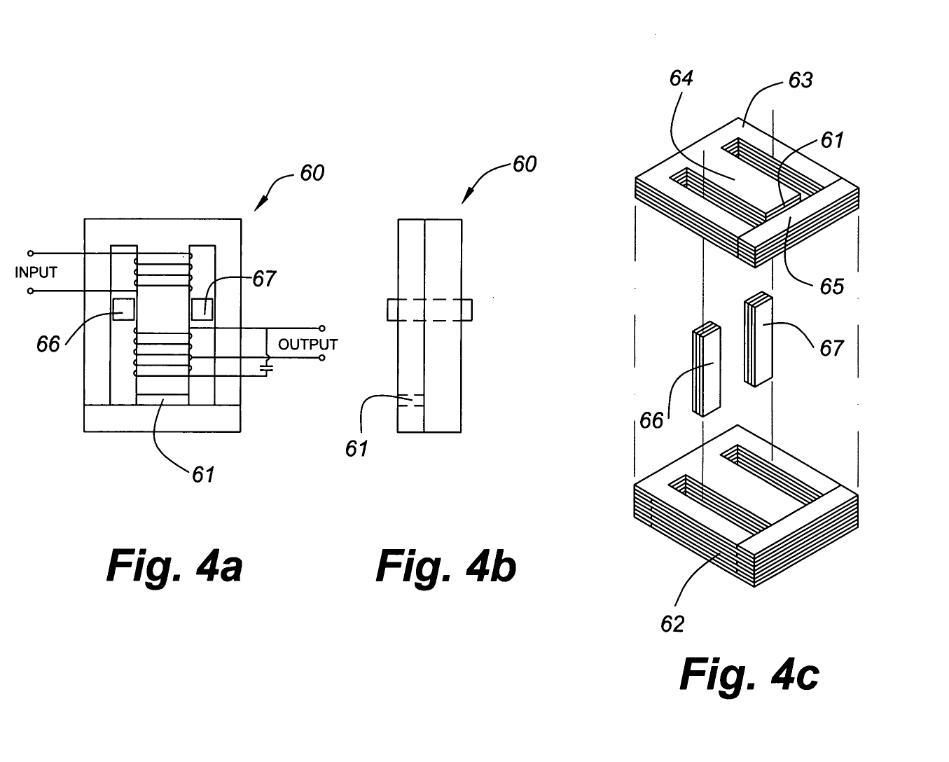

FIGS. 4a-4c show a transformer 60 that has a partial air gap 61 formed by using a stack of laminations having two basically similar E-I patterns, except that, as is most easily seen in FIG. 4c, all three legs of the E laminations the bottom sub-stack of laminations 62 form interleaved stacks with I laminations and, thus have no air gap. The top sub-stack of laminations 63, on the other hand, does have the air gap 61 between the winding leg 64 and the I laminations 65. The transformer 60 also includes magnetic shunts 66 and 67 similar to the shunts 37 and 38 in FIG. 1.

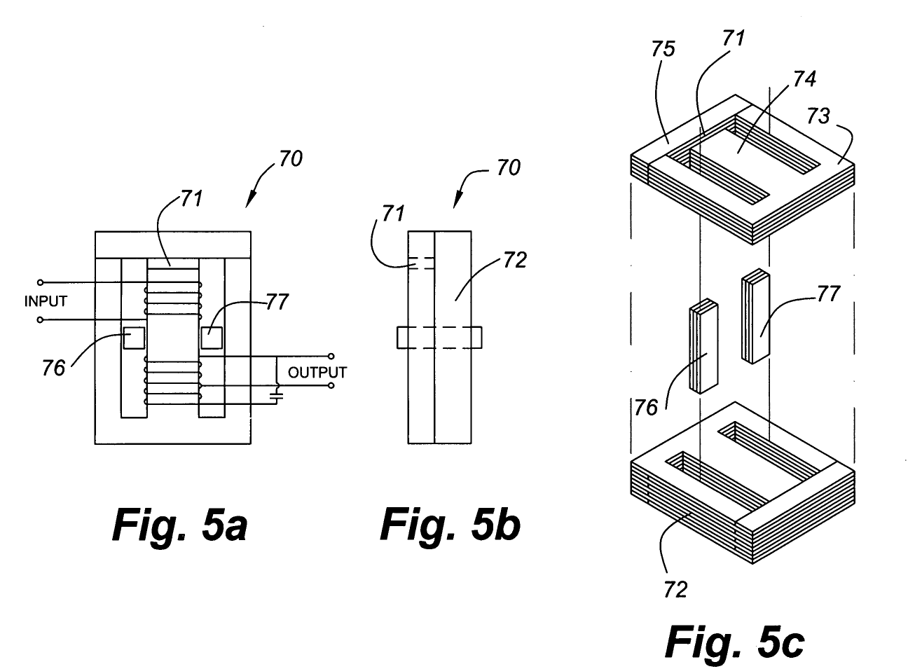

FIGS. 5a-5c show a transformer 70 that differs from the transformer 60 in FIG. 4a-4c, having a partial air gap 71 at the primary winding end of the winding leg. The core consists of a lower sub-stack of laminations 72 without any air gap and a matching upper sub-stack 73 with the air gap 71 between the end of the slightly short winding leg 74 and the adjacent stack of I laminations 75. The built-in inductor still has the high-reluctance magnetic path through the air gap of the partial stack 73 to get the same effect as the embodiment shown in FIG. 1. The thickness of the sub-stack 72 need not be equal to the thickness of the sub-stack 73 but depends on other requirements of the transformer. Magnetic shunts 76 and 77 are arranged on each side of the winding leg 74 in an arrangement similar to the shunts 37 and 38 in FIG. 1.

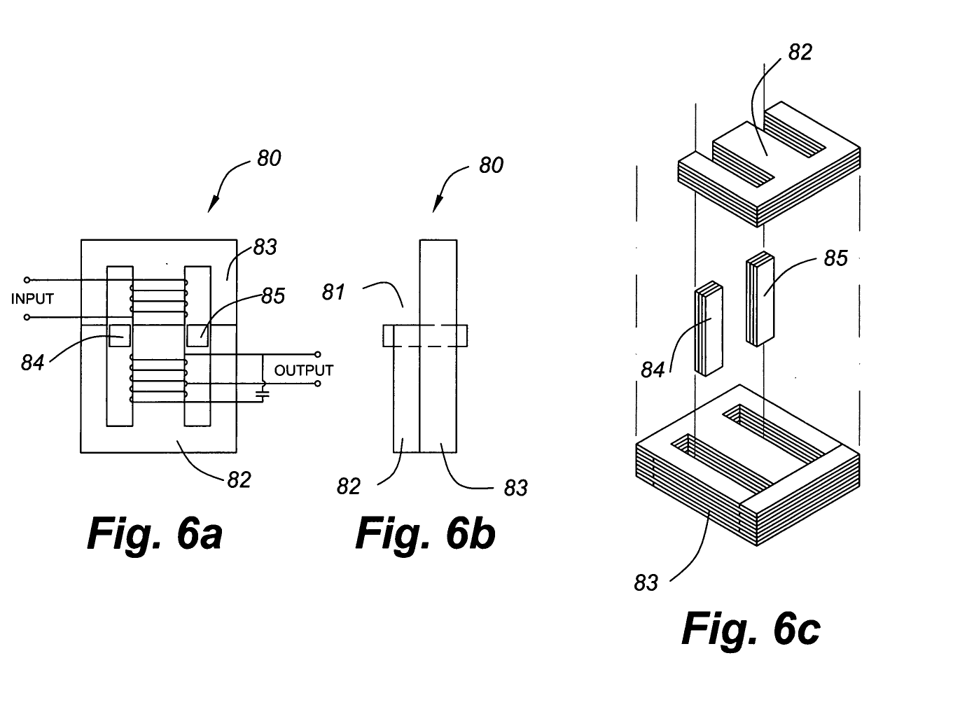

In the embodiment in FIGS. 6a-6c, a transformer 80 is shown with a substantially longer air gap 81 defined by a short E stack 82 aligned with an E-I stack 83 that has no air gap. The ends of the legs of the short stack terminate at the upper surfaces (in FIGS. 6a and 6b) of magnetic shunts 84 and 85. The air gap 81 has the same effect as the partial air gap 49 in FIG. 1.

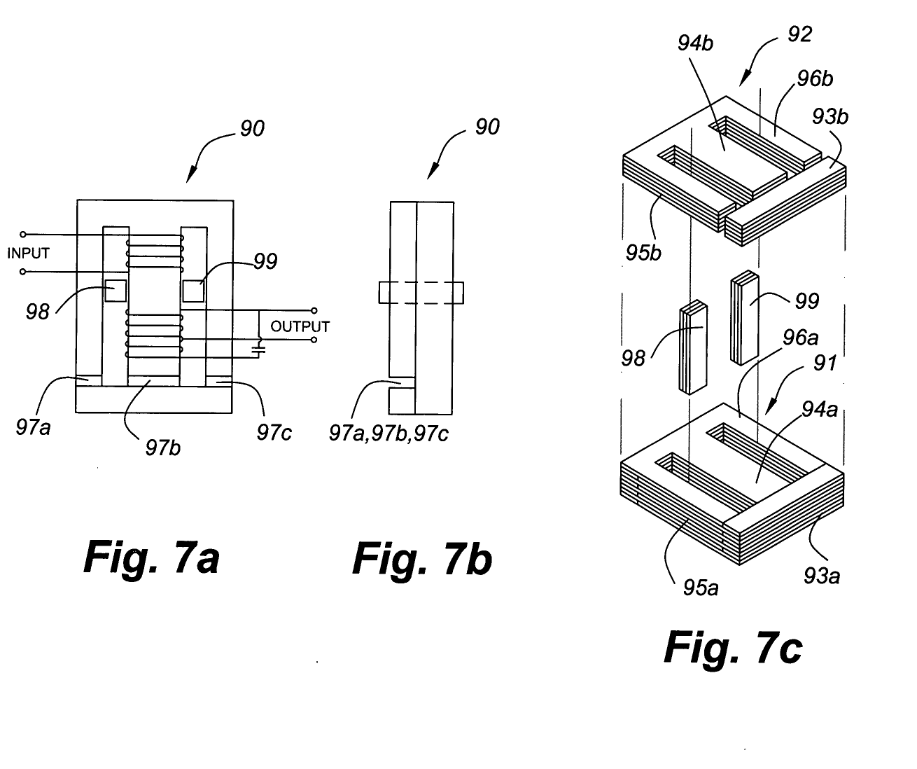

FIGS. 7a-7c show a transformer 90 with a core formed of two sub-stacks 91 and 92 of E-I configuration. The sub-stack 91 includes I laminations 93a and E laminations having three legs: a winding leg 94a and two return legs 95a and 96a, all of which are long enough to meet the I laminations 93a. The sub-stack 92 has a winding leg 94b and two return legs 95b and 96b aligned with the legs 94a-96a, respectively, but somewhat shorter so that they do not extend to the I laminations 93b of the sub-stack 92, thereby forming partial air gap means divided into three parts 97a-97c. Shunts 98 and 99 are located between the winding legs 94a and 94b and the return legs 95a, 95b and 96a, 96b. The net effect of the three-part air gap in the transformer 90 is the same as having the single, partial air gap 49 in FIG. 1.

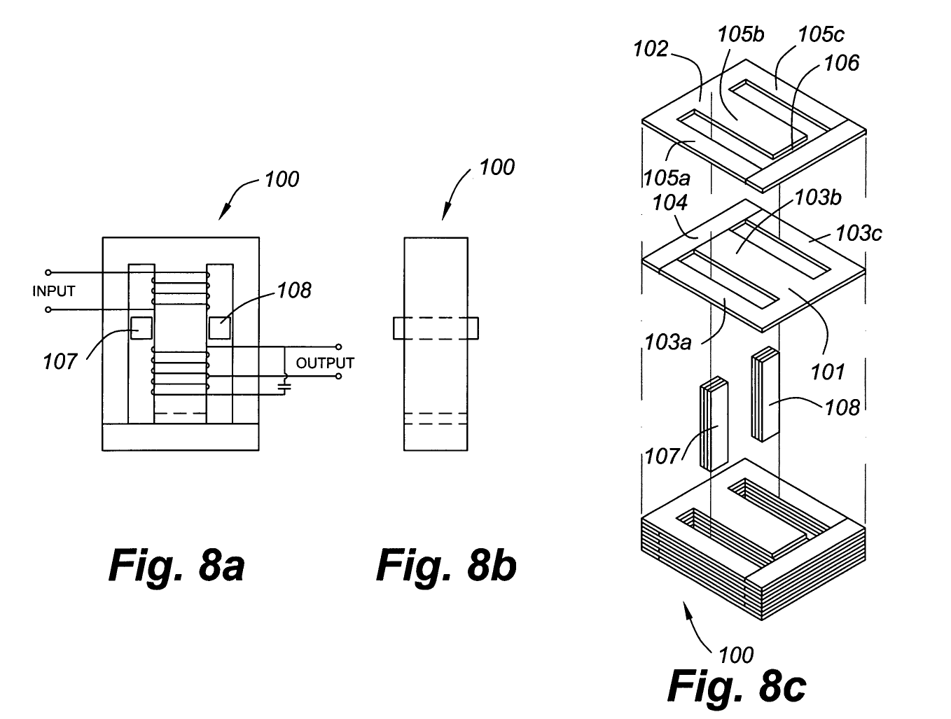

In the embodiment in FIGS. 8a-8c, a transformer 100 has two sets of E-I laminations 101 and 102 interleaved with each other rather than being separated into stacks. In the first set of E-I laminations 101, all three of the legs 103a-103c butt aganist the I laminations 104, leaving no air gaps. In the laminations 102, the return legs 105a and 105c are longer than the central, winding leg 105b, thus leaving an air gap 106. Since this air gap is only in the laminations 102, it constitutes a partial air gap for the complete transformer 100. It should be noted that the laminations 101 do not have to be equal in number with the laminations 102. That is, the cross-sectional area of the magnetic material 103b in the laminations 101 that bridges the air gap 106 in the layers 102 does not have to be 50% of the total cross-sectional area. it might be more or less, depending on the requirements of operation. As in the prior embodiments, the transformer 100 comprises magnetic shunts 107 and 108 on each side of the central legs 103b and 105b.

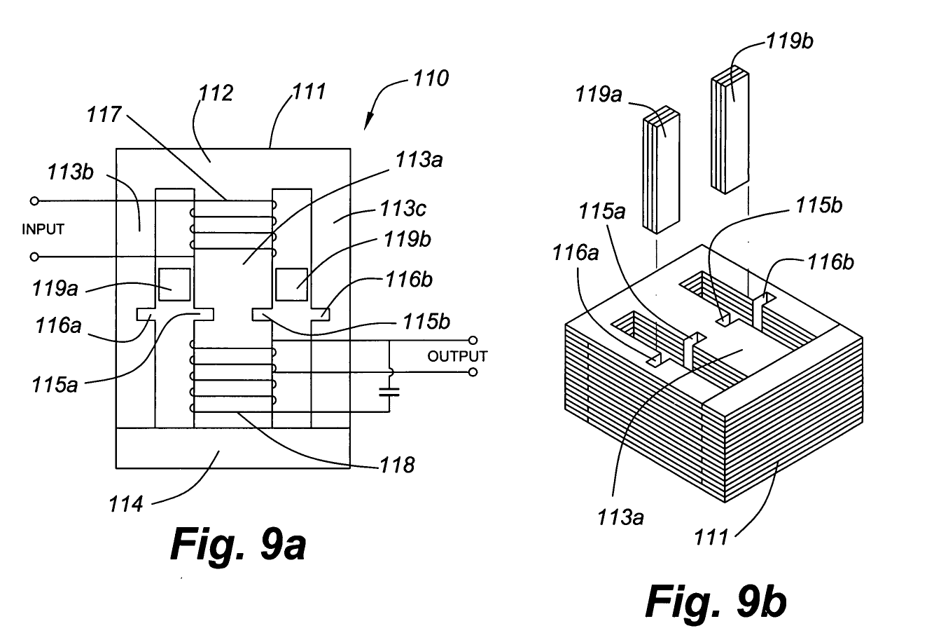

FIGS. 9a and 9b show a transformer 110 formed of a single stack of special E-I laminations 111 oppositely interleaved with each other in the manner of the laminations 101 and 102 in FIG. 8c. Each one of the E laminations 111 has a spine 112 from which extend three legs: a central winding leg 113a and two return legs 113b and 113c, all of the same length so that they all engage the I lamination 114 of that layer. Partial air gaps 115a and 115b are formed on opposite sides of the central region of the winding leg, and additional partial air gaps 116a and 116b are formed in the surfaces of the return legs facing the winding leg 113a. By forming the partial air gaps 116a and 116b directly opposite the partial air gaps 115a and 115b and all of these partial air gaps at the midpoint of the length of the legs 113a-113c, all of the E laminations are identical with each other and may be formed on a single cutting die.

A primary winding 117 is located on the winding leg 113a between the partial air gaps 115a and 115b and the spine 112, and a secondary winding 118 is located between the partial air gaps and the other end of the winding leg. All of these partial air gaps reduce the cross-sectional area of their respective legs to increase the reluctance of the paths through those regions. Although two sets of partial air gaps 115a, 115b and 116a, 116b are shown, it is not necessary to have all four partial air gaps. Either set can be eliminated and the depth and width of the partial air gaps of the other set modified to achieve the required reduction in cross-sectional area. As in the previous embodiments, the transformer 110 includes magnetic shunts 119a and 119b on opposite sides of the central leg 113a between the partial air gaps and the primary winding.

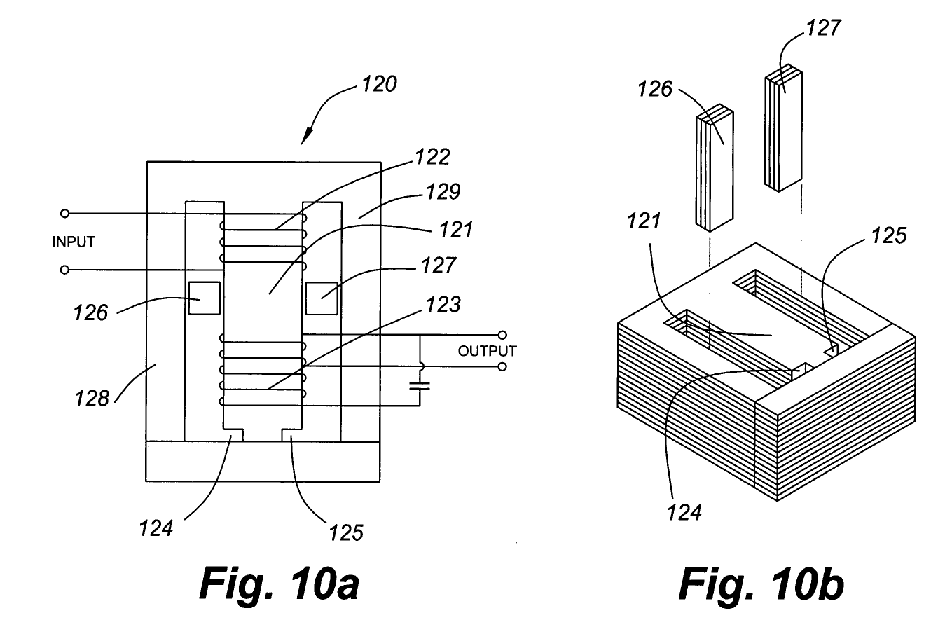

FIGS. 10a and 10b show yet another modification of the invention in which a transformer 120 has a central, winding leg 121 with a primary winding 122 toward one end and a secondary winding 123 toward the other end. Partial air gaps 124 and 125 are arranged on opposite sides of the secondary-winding end of the winding leg, which results in a reduction in the cross-sectional area of the winding leg and produces the built-in inductor similar to that discussed in FIGS. 4a-4b. This arrangement of the air gaps has the advantage that all of the laminations can be alike. As in the prior embodiments, the transformer 120 includes magnetic shunts 126 and 127 located between the central, winding leg and return legs 128 and 129 and between the primary and secondary windings 122 and 123.

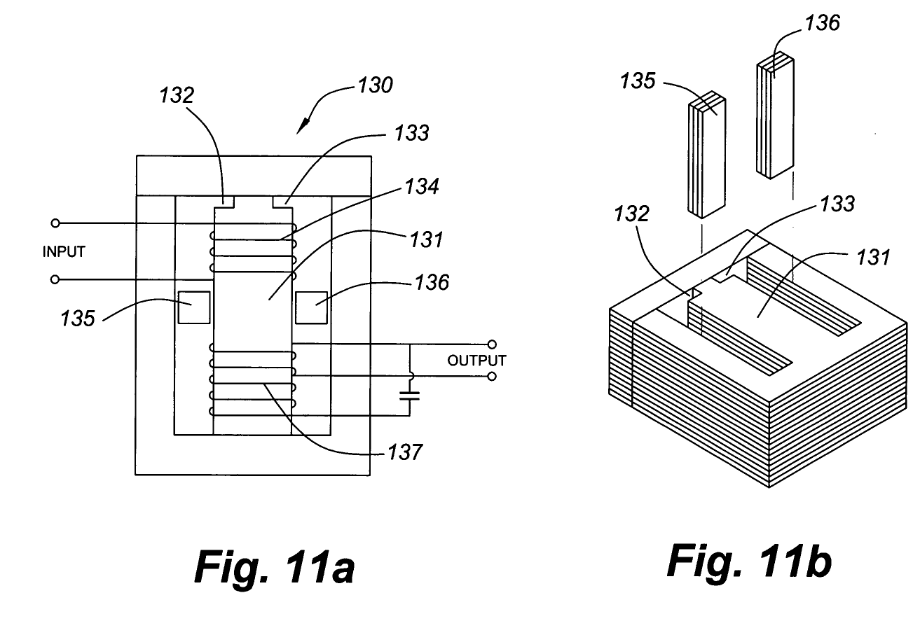

Similarly, FIGS. 11a and 11b show a transformer 130 that has a central, winding leg 131 with a partial air gap formed by two notches 132 and 133 the end on which a primary winding 134 is located. Magnetic shunts 135 and 136 are located between the primary winding and a secondary winding 137. As in the embodiments in FIGS. 9 and 10, the transformer 130 can be made with only one set of E-I laminations.

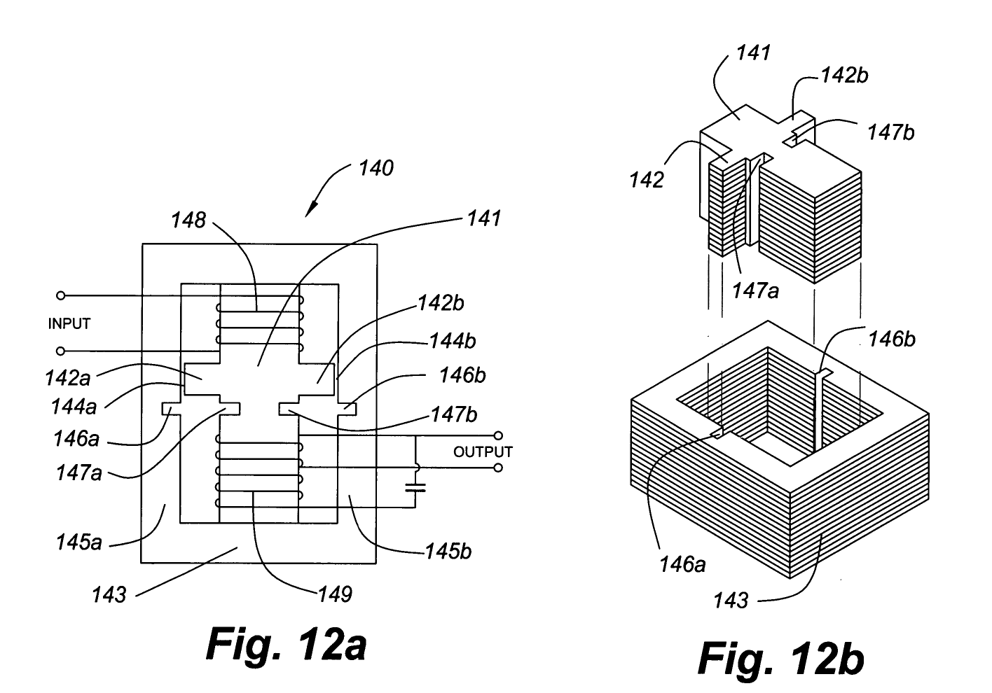

FIGS. 12a and 12b show a transformer 140 very similar to the transformer 110 in FIG. 9a except that the transformer 140 has laminations of T-O, or cruciform, configuration in which the T laminations constitute a central winding leg 141 with magnetic shunt means 142a and 142b extending outwardly from it rather than being spaced from it, as are the magnetic shunt means of the prior embodiments. However, the magnetic shunt means 142a and 142b do not extend far enough out from the winding leg to touch the inwardly facing surfaces of the O laminations 143 that encircle, or surround, the T laminations. Thus, there are still air gaps 144a and 144b that must be traversed by flux that passes through the shunt means 142a and 142b.

The O laminations form the return legs 145a and 145b in this embodiment. Partial air gaps 146a and 146b are formed in inwardly facing surfaces of the return legs 145a and 145b opposite partial air gaps 147a and 147b formed in outwardly facing surfaces of the winding leg 141 between a primary winding 148 and a secondary winding 149, similar to the arrangement of the partial air gaps 115a, 115b and 116a, 116b in FIG. 9a. The primary winding 148 is located on one end of the winding leg 141 with the magnetic shunt means 142a and 142b between the primary winding and the air gaps 147a-147b. A secondary winding 149 is located on the other end of the winding leg, beyond the partial air gaps 147a and 147b.

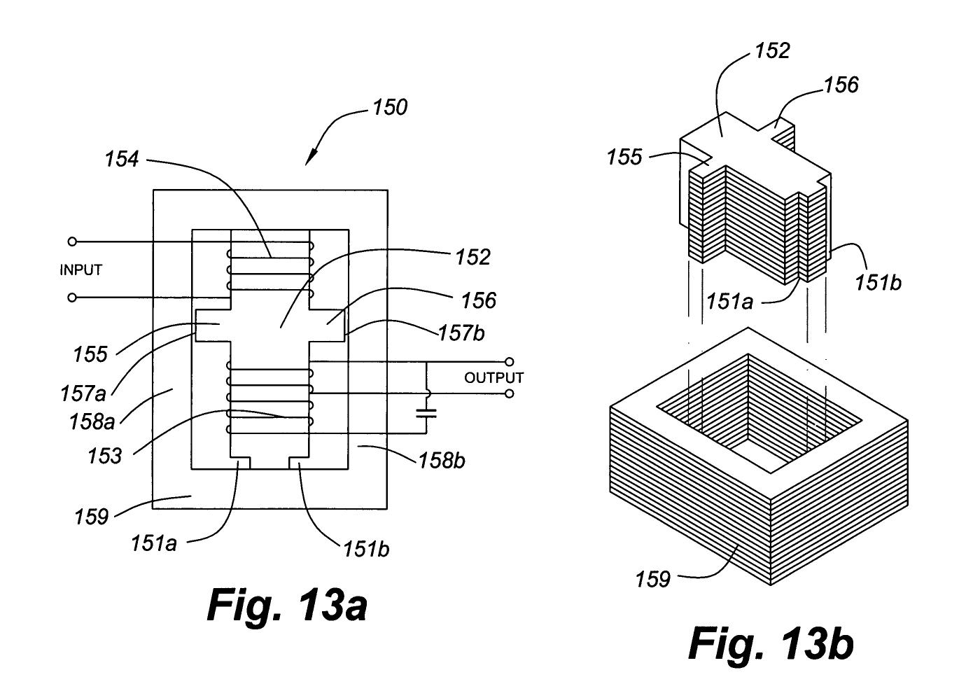

FIGS. 13a and 13b show a transformer 150 that is similar to the transformer 120 in FIG. 10a except that, like the transformer 140 in FIG. 12a, it is formed of T-O laminations. Partial air gaps 151a and 151b are formed by narrowing the end of the central winding leg 152 on which the secondary winding 153 is located, and these partial air gaps function in the same way as the partial air gaps 124 and 125 in FIG. 10a. The primary winding 154 is located on the opposite end of the central winding leg 152, which has magnetic shunt arms 155 and 156 extending from it in the region between the primary and secondary windings. The winding leg 152 and the shunt arms 155 and 156 thus form the T laminations of the transformer 150. As in the prior embodiments, there are air gaps 157a and 157b between the shunt arms and return arms 158a and 158b that form the O laminations 159 of the transformer 150.

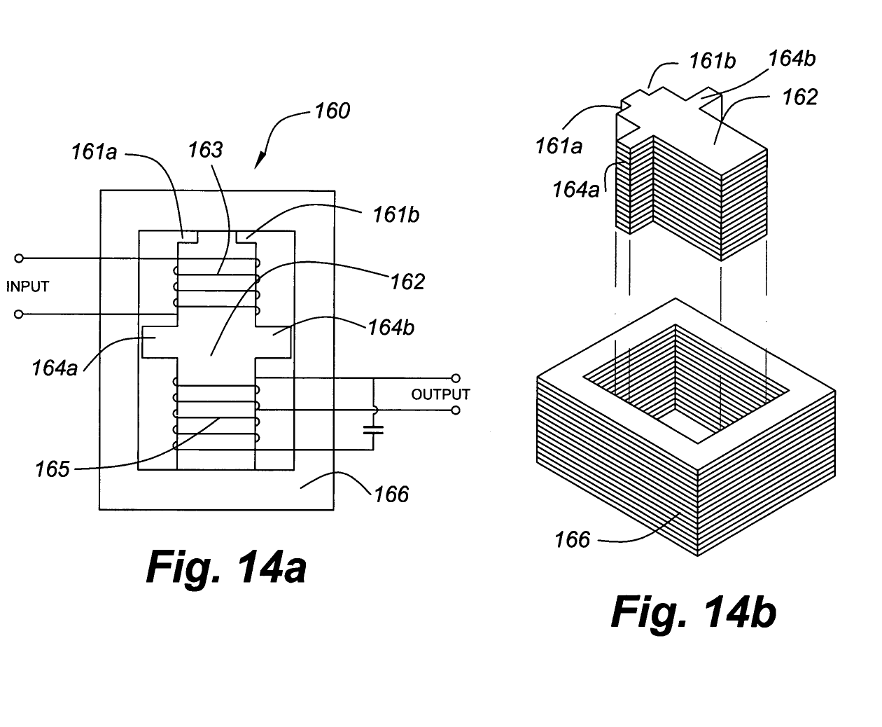

FIGS. 14a and 14b show a transformer 160 that is essentially like the transformer 130 in FIG. 11a except that it is formed of T-O laminations instead of E-I laminations. The transformer 160 has partial air gaps 161a and 161b at the same end of the central leg 162 as the primary winding 163, and these partial air gaps operate in the same way as the partial air gaps 132 and 133 in FIG. 11a. The central winding leg has magnetic shunt arms 164a and 164b extending outwardly from it in a region between the primary winding 163 and a secondary winding 165 and thus constitutes the T laminations of the transformer 160. As in the transformer 150 in FIG. 13a, the O laminations 166 of the transformer 160 encircle the T laminations.

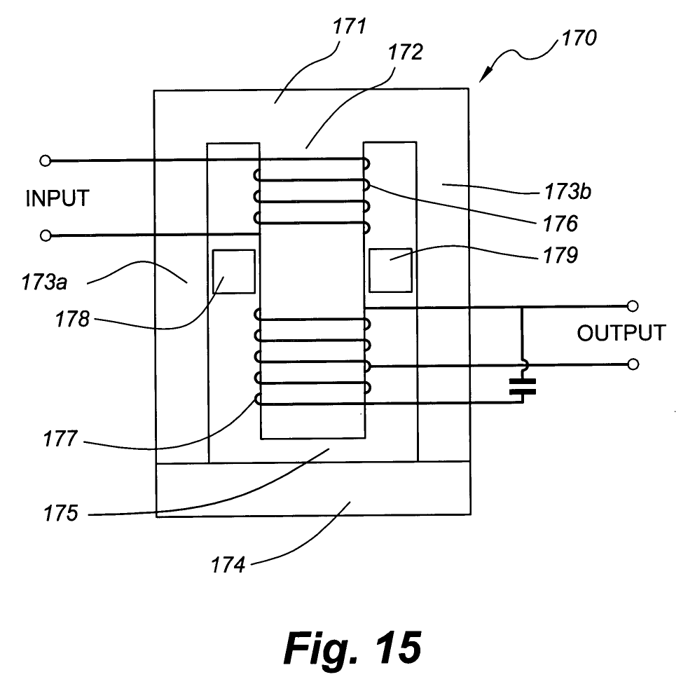

FIG. 15 shows another embodiment 170 of a transformer constructed to include the features of this invention. This transformer is constructed of E laminations that comprise a spine 171 from which extend three legs: a central, winding leg 172 and two slightly longer return legs 173a and 173b. I laminations 174 engage the free ends of the return legs 173a and 173b but are spaced from the end of the leg 172 by an air gap 175. A primary winding 176 is wound on one end of the leg 172, in this case, the end adjacent the spine 171. A secondary winding 177 is wound on the opposite end of the leg 172 adjacent the air gap. Between the primary and secondary windings are magnetic shunts 178 and 179 that serve the same purpose as the magnetic shunts 37 and 38 in FIG. 1. Although the air gap 175 is complete, not partial as in the previous embodiments, it is dimensioned to produce the same effect on the magnetic flux linking the primary and secondary coils as the partial air gaps.

A specific embodiment of the transformer 170 with its full air gap 175 in FIG. 15, has been constructed according to the specifications in the following Table III:

TABLE III

| | |
|---|---|
| VA rating: | 600 VA at 60 Hz |
| Input voltage: | 120 Volts ±15% |
| Output voltage: | 120 Volts ±3% |
| Lamination core with air gap: | 2″ Stack Of FR-1625, M6, |
| | 29-gauge laminations with 0.1″ |
| | air gap in the center leg |
| Shunt assembly, each: | 0.63″ stack of M6, 29-gauge |
| | laminations with 0.031″ shunt air |
| | gap |
| Primary coil: | 130 turns for input |
| Secondary coil: | 450 turns, tapped @ 102 turns for |
| | output |
| Capacitor: | 33 μF |

The results are stated in the following Table II:

TABLE IV

| | | | | | Tot. Harm. |
|---|---|---|---|---|---|
| Input | | Output | | Regulation | Distort'n |
| 102 V | 6.54 A | 106.7 V | 5.43 A | 2.5% under 109.4 V | 1.1% |
| 120 V | 5.82 A | 109.4 V | 5.50 A | | 2.2% |
| 138 V | 5.58 A | 110.5 V | 5.53 A | 1.0% over 109.4 V | 3.9% |

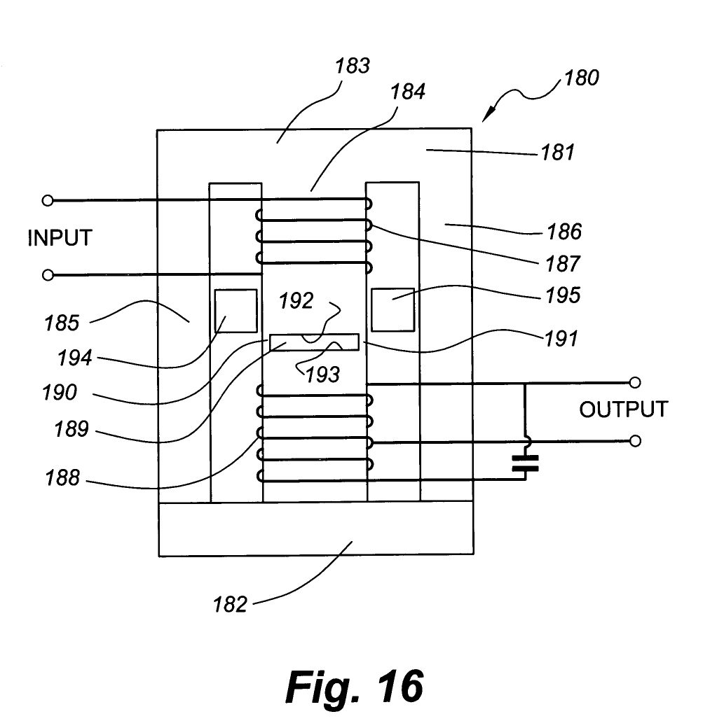

FIG. 16 shows another version of a transformer 180 incorporating the features of this invention and comprising a stack of E-I laminations 181 and 182. Each E lamination 181 includes a spine 183 from which extend a central, winding leg 184 and two return legs 185 and 186, all of the same length. The I laminations 182 are thus able to engage all of the legs 184-186. A primary winding 187 is located at the end of the winding leg 184 adjacent the spine 183 and a secondary winding 188 is located in the other end portion of the winding leg adjacent the I laminations 182. Between the windings is a partial air gap 189 that extends less than all the way across the winding leg 184. Two narrow bridges 190 and 191 of the ferromagnetic material out of which the laminations are formed hold confronting surfaces 192 and 193 of the air gap apart to minimize the noise that would otherwise be generated by the alternating magnetic flux in the winding leg 184. Furthermore, the air gap 189 is located midway between the spine 183 and the I laminations 182, and the dimensions of the spine are the same as those of the I lamination, so that alternate laminations can be oppositely oriented, i.e., with the I lamination of one layer laid in surface-to-surface contact with the spine of the next layer. When the core is so constructed, all of the air gaps 189 will be aligned with each other. This minimizes the effect of any gap between the ends of the legs 184-186 in the whole stack. The transformer 180 has magnetic shunt means 194 and 195 located on opposite sides of the leg 184 between the air gap 189 and the primary winding 187, corresponding in location and operation to the shunts 119a and 119b in FIG. 9.

Some of the characteristics of those of the foregoing transformers that have a partial air gap as compared with those that have a whole air gap may be summarized as follows:

| Characteristics | Partial air gap | Whole air gap |
|---|---|---|
| Power Output | Little more | |
| Total Harmonic Distortion | <5% | <3% |
| Line Regulation | Little better | |
| Load regulation | Little better | |

In addition to transformers operating on single-phase alternating current, transformers incorporating the novel features of this invention can also operate on multi-phase alternating current.

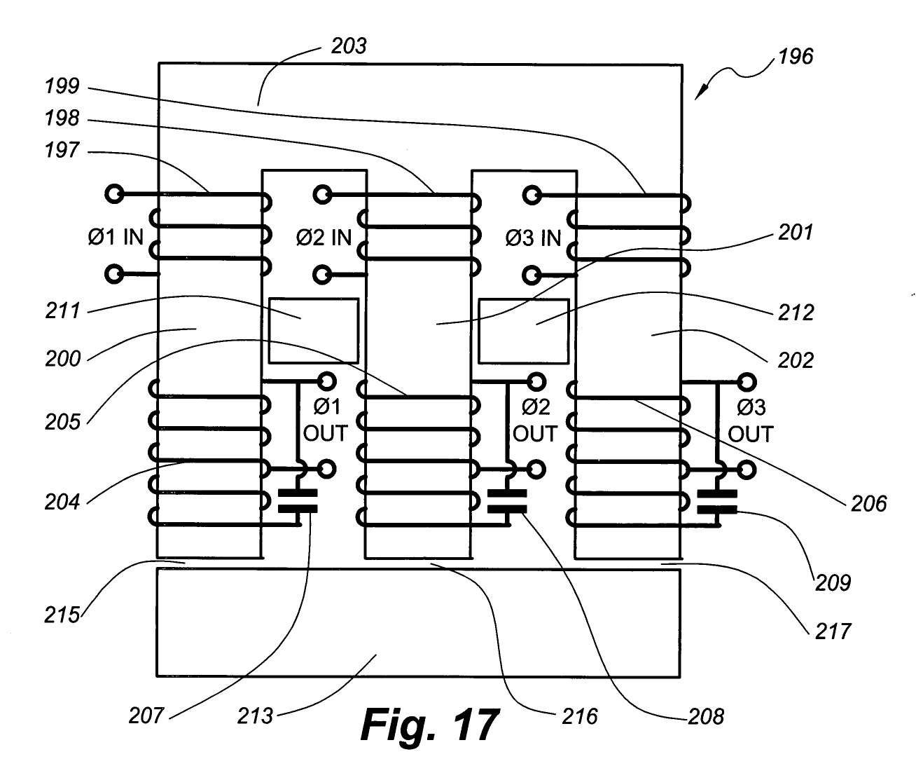

FIG. 17 shows a transformer 196 arranged to operate on three-phase alternating current. For this purpose, it has three primary windings 197-199 to be connected to the three phases of the supply current. These windings are wound on legs 200-202 of the E laminations of an E-I stack. The legs 200-202 extend from a spine 203 and each serves as the winding leg for one phase of the alternating current. At the same time, each pair of these legs serves as the return legs for flux produced by the primary winding on the third leg. By forming the legs with equal dimensions, the response of each is the same to the alternating current applied to their respective primary windings.

Secondary windings 204-206 are wound on opposite ends of the legs 200-202 from the primary windings 197-199, respectively. Capacitors 207-209 are connected to the secondary windings in the same way the capacitor 51 is connected to the secondary winding 26 in FIG. 1 and operate in the same way.

Only two magnetic shunts 211 and 212 are provided, one between the legs 200 and 201 and the other between the legs 201 and 202, and there is an air gap between each end of each of these shunts and the proximal leg. The shunts serve the same purpose as the shunts in the single-phase transformers described above.

The I laminations 213 of the transformer 196 are spaced from the free ends of the legs 200-202 to form air gaps 215-217 that serve the same purpose for each phase as the partial air gap 49 in FIG. 1.

In operation, the leg 200 serves as the winding leg for the voltage applied to the primary winding 197 on that leg, and the legs 201 and 202 will then serve as the return legs for that phase voltage. At the same time, the legs 201 and 202 serve as the winding legs for the other two voltage phases applied to the primary windings 198 and 199, respectively.

The fact that the I laminations are separated from the E laminations is important in providing the inductance to be tuned by the capacitors 207-209, but that spacing between the E and I laminations allows some vibrations to take place between them, so that the transformer 196 is somewhat noisy.

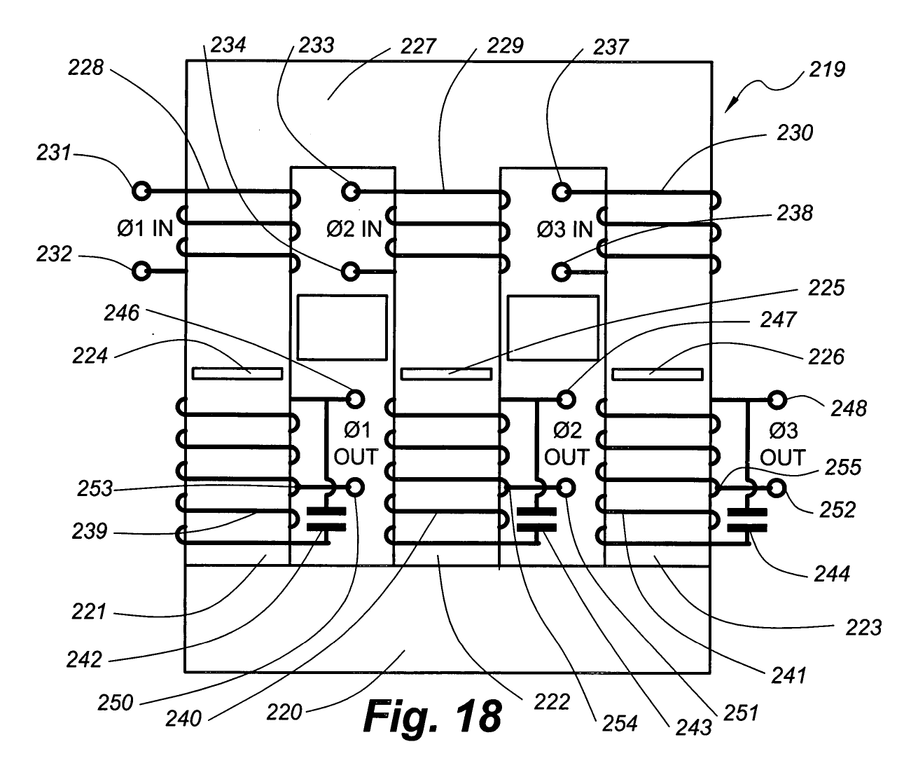

To minimize or eliminate this noise, FIG. 18 shows a transformer 219 with the same three-phase structure as the transformer 196 in FIG. 17 except that, instead of complete separation of the I laminations 220 from the free ends of the three legs 221-223 of the E laminations, each of the legs has a central, partial air gap 224-226 with narrow bridges, like the single, partial air gap 189 in FIG. 16. The spine 227 of each E lamination has the same dimensions as the I lamination 220, thus permitting each set of E and I laminations to be oppositely oriented from the next layer in the stack of these laminations. This arrangement of the stack of E-I laminations forms a rigid core structure for the transformer 219, as in the transformer 180 in FIG. 16.

Primary windings 228-230 are wound on the winding legs 221-223, respectively, to be connected to a three-phase power source by three pairs of input terminals 231, 232, 233, 234, and 237, 238, respectively. Secondary windings 239-241 are also wound on the same legs 221-223 as the primary windings 228-230, respectively. Three capacitors 242-244 are connected across the windings 239-241, respectively, and each of the windings 239-241 has an output terminal 246-248 connected to one end, and to one terminal of the respective capacitor 242-244. Each of these secondary windings also has a second output terminal 250-252 connected to an intermediate point 253-255 to allow each of these primary and secondary winding sets on the legs 221-223 to operate with respect to one of the three phases as the single primary and secondary winding set 24 and 26 did in FIGS. 1-3.

The transformer 219 has two magnetic shunts 256 and 257 located on opposite sides of the center leg 222 between that leg and the two side legs 221 and 223 as does the transformer 196 in FIG. 17. As in the transformer 180 in FIG. 16, the shunts 256 and 257 are alongside that portion of the center leg between the partial air gap in that leg and the primary winding.

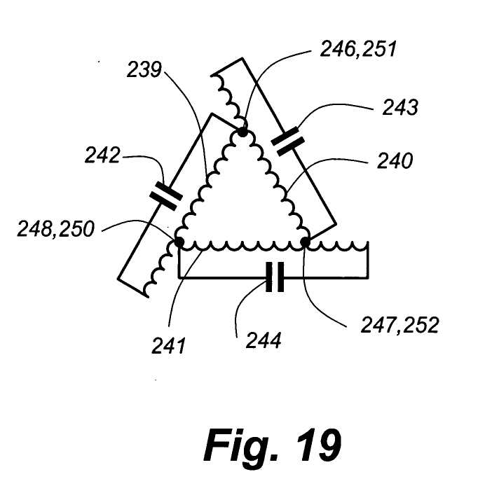

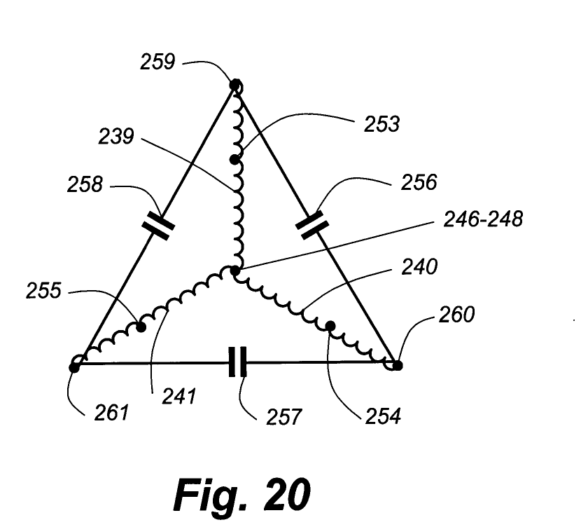

FIGS. 19 and 20 show two different ways the secondary windings of a three-phase transformer, such as the transformer 219 in FIG. 18, may be connected. FIG. 19, which is a delta connection, shows the output terminal 246 at one end of the secondary winding 239 connected to the other output terminal 251 of another secondary 240. One terminal of the capacitor 242 is connected to the junction of the terminals 246 and 251, and the other terminal of that capacitor is connected to the other end of the winding 239. In a similar manner, the terminals 247 and 248 are connected to the terminals 252 and 250 of the windings 240 and 241, respectively, and to one terminal of each of the capacitors 243 and 244, respectively.

In the wye-connected circuit in FIG. 20, the three terminals 246-248 of the windings 239-241, respectively, are connected together as a neutral point. The terminals 253-255 then become the output terminals. Three capacitors 256-258 are connected to the ends 259-261 of the windings 239-241, but unlike the circuit in FIG. 19, are not connected to the terminals 246-248. Instead, the capacitor 256 is connected directly between the ends 259 and 260, and, in like manner, the capacitors 257 and 258 are connected directly between the terminals 260 and 261 and between the terminals 261 and 259, respectively. As a result, the voltage across each of these capacitors is the vector sum of the two windings across which they are connected, and the substantially constant, substantially harmonic-free output voltage between the common terminal 246-248 and each of the terminals 253-255 is less than the voltage across each of the capacitors. The capacitance of each of the capacitors 256-258 is one-third that of the capacitors 242-244 in FIG. 19, assuming that the windings 239-241 in FIG. 20 are physically the sane as the windings 239-241 in FIG. 19 except for being wye-connected instead of being delta-connected.

While the invention has been illustrated by specific embodiments, it will be understood by those skilled in the transformer art that modifications may be made in them that still fall within the scope of the invention as claimed.

1. A ferroresonant transformer that produces, in response to alternating source voltage having a certain frequency, an output voltage substantially free of harmonics and having a substantially constant magnitude, said transformer comprising:
(a) a core loop of low-reluctance transformer material having a selected length and comprising:
(i) ferromagnetic winding leg means to conduct magnetic flux, and
(ii) a ferromagnetic return leg means to conduct magnetic flux;
(b) primary winding means located on a first part of the winding leg means and comprising input terminals to receive the alternating source voltage to produce the magnetic flux in the winding leg means;
(c) secondary winding means on a second part of the winding leg means spaced from the first part of the winding leg means and comprising a plurality of terminals, including output terminals;
(d) air gap means comprising a region of increased reluctance in the core loop to form an inductor in series with the secondary winding;
(e) magnetic flux shunt means, including a series shunt air gap, magnetically joining a location on the winding leg means between the first and second parts thereof to the return leg means to divert from the winding leg means to the return leg means a portion of the magnetic flux produced by the primary winding so that the flux thus diverted by-passes the secondary winding; and
(f) capacitor means connected between selected terminals of the secondary winding and having a capacitance that resonates with the secondary winding means at the certain frequency, whereby the substantially harmonic-free sinusoidal output voltage of substantially constant magnitude is produced across the output terminals.

2. The ferroresonant transformer of claim 1 in which: the core comprises stacked transformer core laminations, the winding leg means is an elongated part of the core, the return leg means bridges the winding leg means and, together with the winding leg means, defines a window, the primary winding is located nearer one end of the winding leg mean than the other end thereof, the secondary winding is located between the primary winding and the other end of the winding leg means.

3. The ferroresonant transformer of claim 2 in which: the air gap means comprises a region of the core laminations having a reduced cross-sectional area at a selected location.

4. The ferroresonant transformer of claim 3 in which the secondary winding is between the selected location and the primary winding.

5. The ferroresonant transformer of claim 3 in which the selected location is between the primary and secondary windings.

6. The ferroresonant transformer of claim 3 in which the primary winding is between the selected location and the secondary winding.

7. The ferroresonant transformer of claim 5 in which the selected location is substantially at the center of the winding leg means.

8. The ferroresonant transformer of claim 2 in which:
(a) the laminations comprise a plurality of sets of E laminations and I laminations, the E and I laminations of each set having the same thickness;
(b) each of the E laminations comprises:
(i) a spine of a selected length and width,
(ii) a central leg, and
(iii) two side legs of equal same length;
(c) each of the I laminations has substantially the same length and width as each of the spines and abuts the distal ends of the side legs;
(d) the air gap means comprises a gap between the central leg and the I lamination of at least some of the sets of E and I laminations.

9. The ferroresonant transformer of claim 8 in which the air gap means extends at least half way across the central leg at a location substantially half way between the spine and the distal end of the central leg, whereby all of the air gap means in a stack of said laminations are aligned with each other when the I laminations in some layers are aligned with the spines of the laminations in other layers.

10. The ferroresonant transformer of claim 2 in which:
(a) the laminations are in three sets, each set comprising an E lamination and an I lamination, the E lamination of each set comprising three legs of equal length;
(b) a respective primary winding on a first portion of each leg to be energized by the source voltage;
(c) a respective secondary winding on a second portion of each leg spaced from the first portion and electrically insulated from, but magnetically coupled to, the one of the primary windings on the same leg portion, each of the secondary windings comprising respective output terminals, whereby each leg serves as a winding leg for the respective primary and secondary windings thereon, and each leg serves as a return leg for each of the windings on the other two legs;
(d) air gap means at a predetermined location in each leg between the primary and secondary windings on that leg;
(e) magnetic flux shunt means joining a location on each leg between the primary ad secondary windings on that leg to a corresponding location of each of the other legs; and
(f) a plurality of capacitors, each connected across a respective one of the secondary windings and having a capacitance that resonates with the respective secondary winding at the certain frequency, whereby the substantially harmonic-free output voltage of substantially constant magnitude is produced across the output terminals.

11. A ferroresonant transformer of claim 10 in which all of the legs on each E lamination are the same length and are spaced from the corresponding I lamination to form the air gap means.

12. A ferroresonant transformer of claim 10 in which the central leg of each lamination has a partial air gap centrally located therein.

13. A ferroresonant transformer that produces a substantially harmonic-free output voltage of substantially constant magnitude in response to an alternating source voltage having a certain frequency and a magnitude within a predetermined value, said transformer comprising:
(a) a stack of ferromagnetic laminations of substantially uniform configuration defining winding leg means and return leg means, the winding leg means and return leg means, together, forming a closed core loop having a cross-sectional area at every point along its length;
(b) a primary winding on a first portion of the winding leg means to be energized by the source voltage;
(c) a secondary winding on a second portion of the winding leg means spaced from the first portion and conductively insulated from the primary winding and comprising a plurality of terminals, including output terminals;
(d) partial air gap means reducing, but not to zero at any location in the closed core loop, the cross-sectional area of the core at a certain location;
(e) magnetic flux shunt means joining a location on the winding leg means between the first and second portions thereof to the return leg; and
(f) a capacitor connected across the whole secondary winding and having a capacitance that resonates with the secondary winding at the certain frequency, whereby the substantially harmonic-free output voltage of substantially constant magnitude is produced across the output terminals of the transformer.

14. The ferroresonant transformer of claim 13 in which the stack of laminations comprises a first set of laminations in which there is no air gap, and a second set of laminations in which there is an air gap, the second set being stacked in alignment with the first set.

15. The ferroresonant transformer of claim 14 in which:
(a) the laminations defining the winding leg means have a substantially constant width along most of the length of the winding leg means; and
(b) the partial air gap comprises a region of the return leg means in which the laminations are narrower than the substantially constant width along most of the length of the return leg means.

16. The ferroresonant transformer of claim 13 in which the certain location of the partial air gap is between the magnetic shunt means and the secondary winding.

17. The ferroresonant transformer of claim 13 in which the partial air gap means comprises:
(a) a portion of the winding leg means on the side of the primary winding remote from the secondary winding; and
(b) portions of the return leg means adjacent said portion of the winding leg means.

18. The ferroresonant transformer of claim 13 in which the stack of laminations comprises a first set of laminations in which there is no air gap, and a second set of laminations interleaved with laminations of the first set and in which there is an air gap.

19. The ferroresonant transformer of claim 18 in which the number of laminations in one set is equal to the number of laminations in the other set.

20. The ferroresonant transformer of claim 18 in which the number of laminations in one set is greater than the number of laminations in the other set.

21. A ferroresonant transformer that produces a substantially harmonic-free output voltage of substantially constant magnitude in response to an alternating source voltage having a certain frequency and a magnitude within a predetermined value, said transformer comprising:
(a) a core structure comprising a stack of uniform ferromagnetic laminations comprising:
(i) a central winding leg,
(ii) a pair of return legs forming, with the first leg, a pair of closed core loops, each of the legs having a cross-sectional area at every point along its length, and
(iii) magnetic shunt means extending only part way from the winding leg to each of the return legs forming a magnetic flux path between a particular part of the central core leg and the return legs and dividing each of the core loops into two parts;
(b) a primary winding on the winding leg between a first end thereof and the magnetic shunt means;
(c) a secondary winding on the winding leg between the magnetic shunt means and the other end of that leg and conductively insulated from the primary winding and comprising:
(i) first and second terminals, and
(ii) a third terminal between the first and second terminals, the first and third terminals comprising output terminals of the transformer;
(d) a partial air gap in the core reducing, but not to zero, the cross-sectional area of the core at a certain location; and
(e) a capacitor connected between the first and second terminals of the secondary winding and having a capacitance that resonates with the secondary winding at the certain frequency, whereby the substantially harmonic-free output voltage of substantially constant magnitude is produced across the output terminals of the transformer.
